(19) United States
(12) Patent Application Publication
(10) Pub. No.: US 2017/0066695 A1
(43) Pub. Date: Mar. 9, 2017

(54) PRODUCTION OF FLOWABLE NUTRIENTS FOR GROWING CROPS

(71) Applicant: Alig Environmental Solutions, LLC, Ft. Recovery, OH (US)

(72) Inventors: David Dale Alig, Ft. Recovery, OH (US); Gregory K. Alig, Celina, OH (US); Rick E. Alig, Ft. Recovery, OH (US)

(21) Appl. No.: 15/252,406

(22) Filed: Aug. 31, 2016

Related U.S. Application Data
(60) Provisional application No. 62/213,684, filed on Sep. 3, 2015.

(51) Int. Cl. C05F 3/00; C05G 3/00; C05F 3/06

(52) U.S. Cl. CPC C05F 3/00; C05F 3/06; C05G 3/0064

(57) ABSTRACT

A flowable fertilizer having nutrients for a specific crop is produced by conveying a controlled flow of dry manure such as poultry manure into a chopper and blender having a motor driven chopping and mixing member, and a controlled flow of liquid is mixed into the chopped dry manure to produce the flowable fertilizer. The dry manure is weighed as it is conveyed, and the flow of liquid is controlled to produce the optimum fertilizer for a growing crop. In a preferred embodiment, the chopped dry fertilizer and liquid are conveyed and directed into a holding tank having a recirculating agitator, and the tank, agitator and conveyor are carried by a semi-trailer along with a power generator for operating the hydraulic motors for the conveyor, chopper and mixer and the valves within the liquid and flowable fertilizer lines or ducts.

### BACKGROUND OF THE INVENTION

Agricultural fertilizers are commonly produced by mixing phosphorus, potash and other minerals with nitrogen, and the fertilizers are used to feed crops which either feed livestock or are processed into food for feeding people. However, since we may eventually run out of easy-to-obtain nutrients to feed livestock and people, the nutrients being used today need to be recycled.

Virtually all solid or semi-solid manure, such as that generated by chickens and turkeys and livestock, is land applied before a crop is planted. This results in too many nutrients being leached into the environment. For example, most large chicken layer facilities store all the dry manure inside a building until it is applied to crop land before the crop is planted, either in the Fall or in the Spring of the year. As a result, a large amount of nitrogen and parts of other nutrients are leached either into the ground water and/or into streams, rivers and lakes, polluting the water sources and systems. Large lagoons are also used to store the water that has been used to clean eggs before they are delivered to stores, and this water is usually treated as a waste product which must be disposed of at a significant cost.

### SUMMARY OF THE INVENTION

The present invention is directed to a method and apparatus which efficiently produces flowable or liquid nutrients from dry nutrients and which may be applied to a growing crop by use of the method and apparatus disclosed in applicants' published U.S. patent application Ser. No. 14/296,679. For example, the present invention provides for receiving a dry poultry manure, or any other dry material having a nutrient that would enhance crop production, and feeds the material through a system that mixes the proper amount of water or other liquid with the dry material to produce the correct flowable fertilizer to be applied to a growing crop. The system mixes or blends the dry material with water and/or other liquid nutrients at a ratio that results in a flowable fertilizer which is used to feed the growing crop when the mix is applied to a growing crop using the method and apparatus disclosed in the above published patent application. As a result, there is significantly less chance that the mix will leach away into adjacent streams and ground water.

The method and apparatus of the invention may also be used to add municipal sludge or waste to dry livestock or poultry manure to produce a fertilizer which has the correct analysis for a growing crop and thereby provide a responsible and profitable way to apply municipal waste to crops. In order to create the exact fertilizer for a certain crop, it may be necessary to add a commercial fertilizer to the flowable mixture. The system may also be equipped with a device that analyzes the flowable mixture as it exits the machine or apparatus. A computer can then take the analysis and be programmed to adjust the ratio of liquid and dry manure or commercial fertilizer which needs to be added and mixed with the blender to create the best or optimum flowable fertilizer to be delivered to the crop.

In summary of the invention, a dry fertilizer or other dry nutrient material is continuously fed at a controlled rate into an auger or other conveyor which weighs the material as it is being conveyed into a mixing hopper or blender, and a controlled supply of liquid is added to the blender. A programmed computer controls the supply of dry material and liquid fed into the blender according to an analysis of each material and liquid to be blended together. The program also controls rotation of mixing members or blades in a chopper or grinder or the blender so that the blender apparatus will deliver the correct ratio of material and liquid and create the optimum fertilizer for the growing crop. However, all functions or components of the apparatus or machine could also be manually operated to achieve the same result. The final flowable fertilizer is pumped to a holding tank or directly to the flexible drag hose used in equipment disclosed in the above published patent application to be applied to the growing crop.

### BRIEF DESCRIPTION OF THE DRAWINGS

FIG. 1 is a diagrammatic illustration of equipment or apparatus constructed in accordance with the invention for producing a flowable fertilizer or nutrients for a growing crop;

FIG. 2 is an isometric and diagrammatic view of another embodiment of the invention and showing mobile equipment or apparatus for producing a flowable fertilizer or mixture of nutrients for a growing crop;

FIG. 3 is an isometric view of the front end portion of the mobile apparatus shown in FIG. 2;

FIG. 4 is an isometric view of the chopper and grinder used in the apparatus shown in FIG. 2, and

FIG. 5 is a bottom inlet view of a dual outlet blending and recirculating pump or agitator used in the mobile system of FIG. 2.

### DESCRIPTION OF ILLUSTRATED EMBODIMENTS OF THE INVENTION

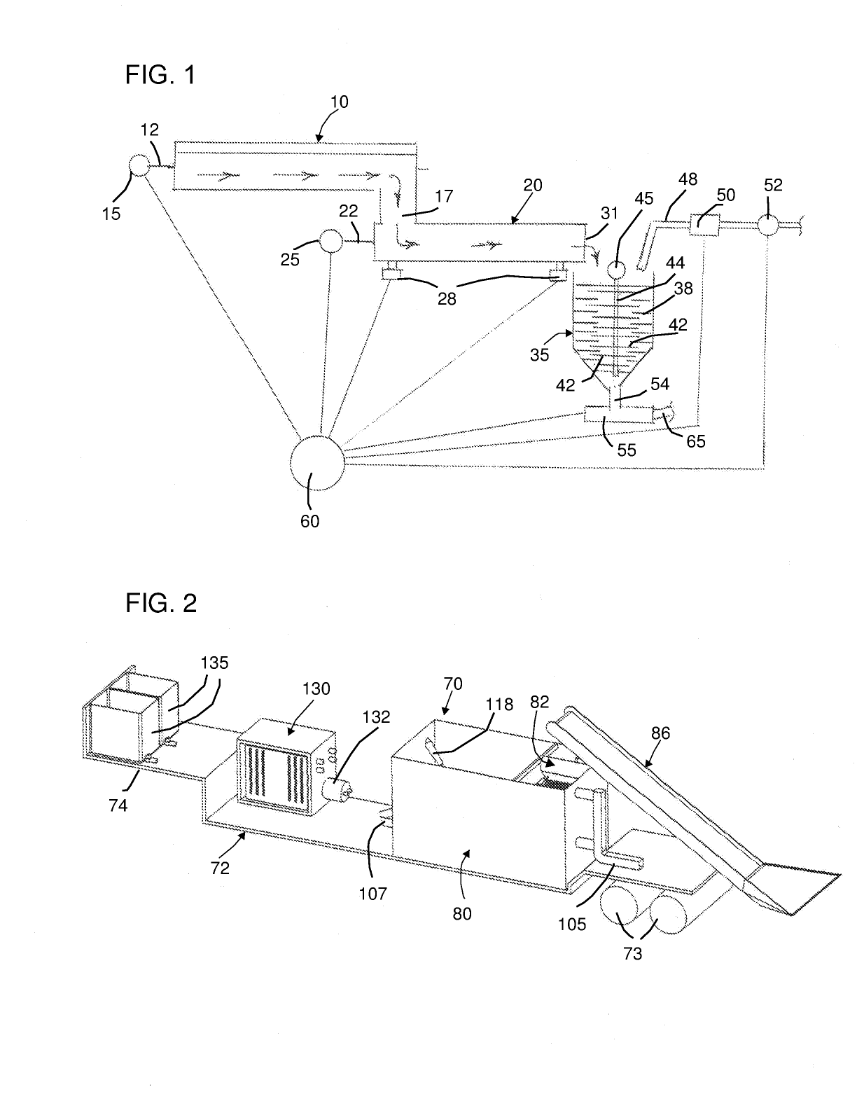

FIG. 1 shows diagrammatically apparatus including an elongated open top charging hopper 10 which receives dry manure or fertilizer and encloses a longitudinally extending auger conveyor having a drive shaft 12 connected to a variable speed motor 15. A consistent and uniform flow of the dry fertilizer is discharged from the hopper 10 through an outlet 17 into the inlet of an elongated weighing conveyor 20 which also has a longitudinally extending auger conveyor having a shaft 22 connected to a variable speed motor 25. The weighing conveyor 20 is supported by a set of load cells 28 which continuously weigh the dry fertilizer within the conveyor 20 before the material is discharged from the conveyor outlet 31 into an open top chopper and mixer or blender 35. One such weighing conveyor 20 is produced and sold under the trademark “Weightronix”.

The blender 35 has vertically spaced stationary cutting members or blades 38 spaced between a series of rotary cutting members or blades 42 mounted on a vertical shaft 44 driven by a variable speed hydraulic motor 45. The blender 35 also receives a supply of flowable liquid through a conduit or line 48 having a flow meter 50 and a control valve 52. The blender 35 chops and mixes or blends the dry fertilizer material from the weighing conveyor 20 with the liquid received through the conduit 48 to produce a flowable fertilizer or material which is discharged through the bottom outlet 54 of the blender into a liquid manure pump 55 such as a manure pump produced by Cadman Power Equipment Ltd. in Courtland, Ontario. For example, ten pounds of dry turkey litter or manure can be blended with two gallons of water or liquid waste to produce about three gallons of flowable fertilizer material. Similarly, five pounds of dry chicken manure can be blended with one gallon of water or liquid waste to produce a flowable fertilizer or material.

While all of the motors and valves may be manually controlled, preferably a computer controlled controller 60 may be connected to control the motors 15, 25 and 45 and is also connected to receive weight information from the load cells 28. The valve 52 and pump 55 may also be controlled by the controller 60. As a result, the motor 15 supplies a consistent and uniform flow of dry fertilizer from the charging hopper 10 into the weighing conveyor 20, and the controller 60 also controls the motor 25 in response to the weight of material in the conveyor 20 as determined by the load cells 28 to provide a controlled predetermined flow of the dried fertilizer material from the weighing conveyor 20 into the blender 35. The analysis of the dry fertilizer supplied to the hopper 10 may be entered into the computer controlled controller 60 along with the analysis of the liquid supplied through the valve 52 and flow meter 50 in the line 48.

Thus the controller 60 controls the ratio of the dry fertilizer and liquid fed into the blender 35 to create the correct or optimum flowable fertilizer for a standing crop. The controller 60 may also be programmed for adding a dry or liquid commercial fertilizer, if desired, to obtain the ideal final analysis for the flowable material discharged from the blender 35 through the outlet 54 into the pump 55. The discharged flowable fertilizer is pumped by the pump 55 through a flexible conduit or hose 65 into a holding tank or to the inlet of a drag hose carried by a reel, as disclosed in the above published U.S. patent application.

It is also within the scope of the invention to use an inclined belt or chain conveyor operated by a variable speed hydraulic motor to feed the dry fertilizer from a bottom hopper which receives the fertilizer. The hopper controls the flow of fertilizer onto an inclined upper conveyor having a portion which is supported by load cells for weighing the fertilizer being fed into the blender. The speed of the conveyor drive motor is controlled by the controller 60 according to the weight and flow rate of the dry fertilizer desired in the blender 35. The operator of the apparatus may also control the apparatus manually by reading the load cells and flow meter, making the calculations and manually adjusting flow rates of dry fertilizer and liquid.

FIG. 2 illustrates a mobile system or apparatus 70 for producing a flowable fertilizer having nutrients and especially suited for applying the fertilizer to a growing crop. In this embodiment, a low bed semi-trailer 72 has a set of rear wheels 73 and a front end portion 74 attached to a tractor (not shown) by a fifth wheel the trailer supports a mixing and holding tank 80 having a rearward portion supporting an open top and open bottom grinder and chopping unit 82 (FIG. 4) having a hopper 84 which receives a controlled flow of dry fertilizer, such as chicken or turkey manure, delivered upwardly by an inclined belt conveyor 86. Preferably, the conveyor has a portion with sensors for weighing the continuous flow of dry fertilizer, such as the load cells 28, and the conveyor 86 has an upper discharge portion connected to the tank 80 by a swivel coupling.

Referring to FIG. 4, the grinder and chopper unit 82 has sets of opposing parallel inclined stationery bars or blades 88 with the sets arranged in a V-shape relation on opposite sides of a rotary cutting member 90 having a helical arrangement of cutting bars or blades 92 projecting radially outwardly from a center shaft 94. The blades 92 are spaced to pass between the stationery knives 88 in response to rotation of the shaft 94 by a hydraulic or electric motor 96 operated from a control valve 97. The opposite end portions of the chopper unit 82 have parallel spaced horizontal bars or blades 102 for collecting any stones or hard objects that are too large to pass between the blades 88, The open bottom of the unit 82 drains into the mixing and holding tank 80. A liquid is pumped into the tank 80 above and below the grate formed by the bars or blades 102 and through a duct or line 105 which extends from a valve and flow meter such as the valve 52 and flow meter 50. As a controlled flow of dry fertilizer is emptied into the grinder and chopper unit 82 by the conveyor 86, the material is broken up and reduced to small pieces by the blades 92 rotating between the blades 88, and the pieces drop into the mixing and holding tank 80 where the pieces of dry fertilizer mix with the liquid supplied to the tank through the inlet duct 105.

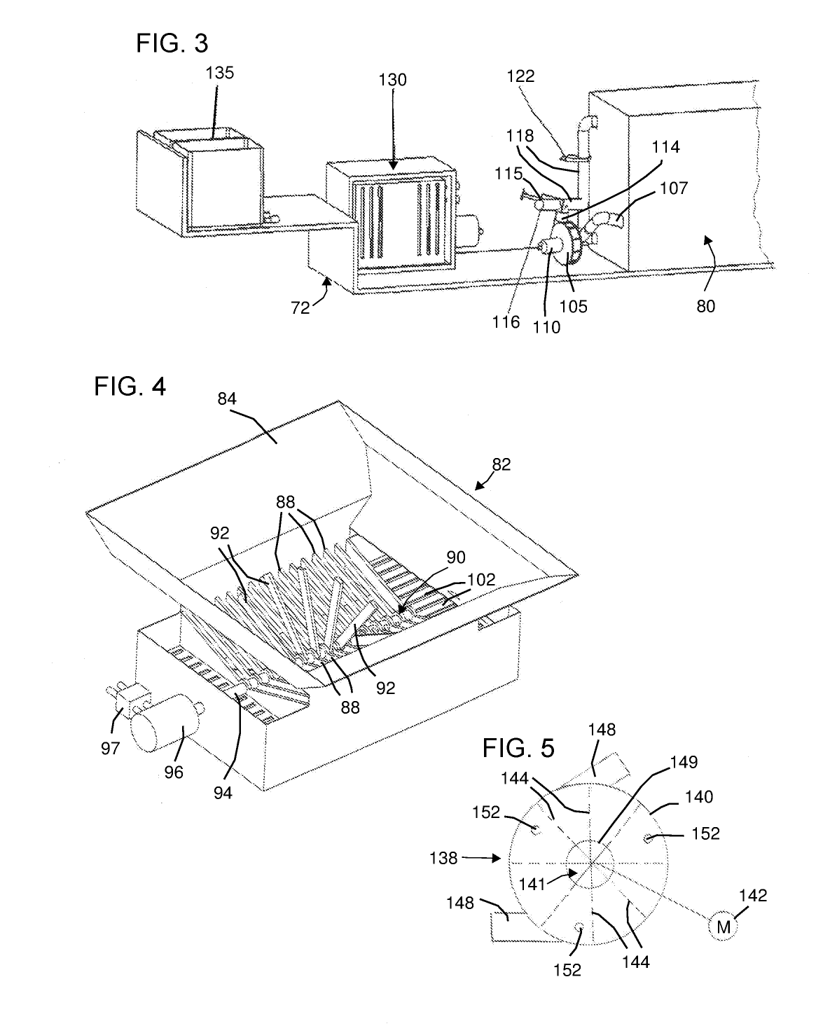

Referring to FIG. 3, the fluid mixture of dry fertilizer and liquid is mixed and agitated within the tank 80 by a recirculating or discharge pump 105 having an inlet connected to a lower portion of the tank 80 by an inlet line or duct 107. The pump 105 has an impeller driven by an electric or hydraulic motor 110, and the pump has an outlet 114 selectively connected by a valve 115 to a discharge duct 116 or to a recirculating line or duct 118 which is connected to both an upper portion and a lower portion of the tank 80 or to only a lower portion by closing a valve 122. The valve 115 selectively directs the flowable mixture of fertilizer and liquid through the recirculating duct 118 or through the outlet duct 116. As mentioned above, the duct 116 directs the flowable mixture of liquid and fertilizer to a holding tank or directly to the inlet of a drag hose as disclosed in the above published patent application.

As shown in FIG. 2, the semi-trailer 72 also carries a power unit 130 which includes an electrical generator driven by a gasoline or diesel engine which also drives a hydraulic pump 132 so that the power unit 130 supplies all of the power required to operate the motors 96 and 110 and the motor for the conveyor 20 or 86. Preferably, the semi-trailer 72 also carries a set of tanks 135 which carry additives such as commercial fertilizers for adding to the tank 80, if necessary, for the desired ratio of liquid and dry manure or commercial fertilizer which needs to be added and mixed in the tank 80.

Referring to FIG. 5, the mixture of dry fertilizer and liquid within the tank 80 is also agitated and recirculated by a dual outlet agitator pump 138 which has a housing 140 enclosing an impeller 141 driven by a hydraulic motor 142. The impeller 141 has circumferentially spaced radial vanes 144, and is enclosed within the housing 140 which has dual outlets 147 and 148 and a center inlet 149. The agitator pump 138 is located within the lower portion of the tank 80 with the inlet 149 facing the bottom wall of the tank and with the pump supported above the bottom wall by three legs 152 secured to the bottom wall of the tank. As mentioned above, all of the hydraulic motors in the embodiment disclosed in FIGS. 2-5 may be operated by the power unit 130 and controlled by a computer which controls the ratio of dry fertilizer and liquid fed into the holding and mixing tank 80 to produce the optimum flowable fertilizer for a standing crop. While the apparatus of the invention is ideally suited by use with the equipment or apparatus and method disclosed in the above published U.S. patent application, it is apparent that the apparatus of the invention may be used for pumping the flowable fertilizer through a drag hose used for distributing the optimum flowable fertilizer onto a field at any time.

We claim:

1. A method of producing a flowable fertilizer having nutrients and adapted to be applied to a growing crop comprising the steps of
feeding a controlled flow of dry manure into a blender having a motor driven mixing member,
directing a controlled flow of liquid into the blender,
blending the dry manure with the liquid to produce a flowable fertilizer having nutrients, and
pumping the flowable fertilizer into a discharge conduit.

2. A method as defined in claim 1 and including the step of weighing the dry manure before feeding the manure into the blender, and measuring the volume of liquid flowing into the blender.

3. A method as defined in claim 1 wherein the step of feeding the dry manure into the blender, comprises directing the manure between stationary blades and rotary blades projecting between the stationary blades.

4. A method as defined in claim 1 wherein the dry manure comprises manure produced by poultry.

5. A method as defined in claim 1 wherein the dry manure comprises manure produced by cattle or hogs.

6. A method as defined in claim 1 wherein the liquid comprises water.

7. A method as defined in claim 1 wherein the liquid comprises waste water produced from cleaning eggs.

8. A method as defined in claim 1 wherein the liquid comprises waste sludge produced from a municipal sewage plant or industrial waste water.

9. A method as defined in claim 1 wherein the dry manure and liquid are directed into a holding tank, and the mixture is agitated and circulated in the holding tank.

10. A method as defined in claim 9 and including the step of supporting the holding tank, a dry manure chopper unit and a mixture agitating system by a mobile wheel-supported trailer bed.

11. A method as defined in claim 10 and including the step of supporting a power generating unit with the mobile trailer bed.

12. Apparatus for producing a flowable fertilizer adapted to be applied to a growing crop, comprising
a conveyor for supplying a controlled flow of dry manure to a blender,
a duct having a valve for supplying a controlled flow of liquid to the blender,
a mixer for blending the dry manure and liquid into a flowable fertilizer, and
a duct for directing the flowable fertilizer into a storage tank or an inlet of a flexible drag hose.

13. Apparatus as defined in claim 12 and including a mobile wheel-supported trailer bed supporting a mixing tank for receiving the dry manure and the liquid, the trailer bed also supporting the mixer for blending the dry manure and liquid, and the trailer bed further supporting a power operated pump for discharging the flowable fertilizer from the mixing tank.

14. Apparatus as defined in claim 13 and including a chopper unit for receiving the dry manure and supported by the trailer above the mixing tank, and the chopper unit including stationery blades spaced to receive rotating blades projecting outwardly from a power driven rotor shaft.
